(19) United States
(12) Patent Application Publication
(10) Pub. No.: US 2013/0012613 A1
(43) Pub. Date: Jan. 10, 2013

(54) METHOD FOR SYNTHESIZING CALIXARENE AND/OR CYCLODEXTRIN COPOLYMERS, TERPOLYMERS AND TETRAPOLYMERS, AND USES THEREOF

(75) Inventor: Mohamed Skiba, Montmain (FR)

(73) Assignee: Drug Research Technology Transfer LLC

(21) Appl. No.: 13/519,642

(22) PCT Filed: Dec. 27, 2010
(86) PCT No.: PCT/FR2010/000875

§ 371 Date: Sep. 24, 2012

(30) Foreign Application Priority Data
Dec. 27, 2009 (FR) 1001777

(51) Int. Cl. C08F 2/46; C08B 37/16; B29B 9/16; C08G 65/38

(52) U.S. Cl. 522/178; 528/219; 536/103; 204/157.68; 264/5

(57) ABSTRACT

A method synthesizes a composition of polymers, copolymers, terpolymers and tetrapolymers. The composition may be made by combining in a reaction chamber, a crosslinking agent and one or more of a calix[n]arene, cyclodextrin, a mixture of a plurality of calix[n]arenes, different cyclodextrins, derivatives of calix[n]arenes, and derivatives of cyclodextrins, stirring the mixture, making a solid residue using microwaves, washing the solid residue, drying some of the wash, filtering some of the wash, and drying the resulting filtered solution. The composition may include alpha-cyclodextrin, beta-cyclodextrin, gamma-cyclodextrin, the derivatives or corresponding mixtures thereof, and/or calix[n]arene(s) and/or of calix[n]arene derivative(s) and/or a mixture of two or more different calix[n]arenes selected from calix[n]arenes (n=4-20) and/or the derivatives thereof. The method has application to pharmaceuticals, human medicine, veterinary medicine, chemistry, separation chemistry, environmental, electronics, biological, diagnostics, phytosanitation, medicinal food, agri-food, cosmetics, the nutraceutical field, and in the field of molecular imprints (MIP).

The present invention relates to a novel process for producing and to the uses soluble or insoluble copolymers, terpolymers and tetrapolymers made from:
cyclodextrin(s) and/or cyclodextrin derivative(s) and/or a mixture of two or three different cyclodextrins,
and/or calix[n]arene(s) and/or calix[n]arene derivative (s) and/or a mixture of two or more different selected from calix[n]arene(s) (n=4-20) and/or the derivatives thereof,
and crosslinking agent and/or a mixture of crosslinking agents, with or without a catalyst (s).

Cyclodextrins are cyclic oligomers composed of 6, 7 or 8 glucose units respectively termed α, β and γ cyclodextrin. Cyclodextrins are known for their ability to include various molecules in their hydrophobic cavity, in particular allowing solubilization in water and biological environments of molecular structures little or not soluble in these mediums and if required, to improve their stability and bioavailability.

The proprieties can be used in fields as varied as the pharmaceutical, human medicine, veterinary medicine, chemistry, phytosanitation, medicinal food, agri-food, cosmetic and nutraceutical.

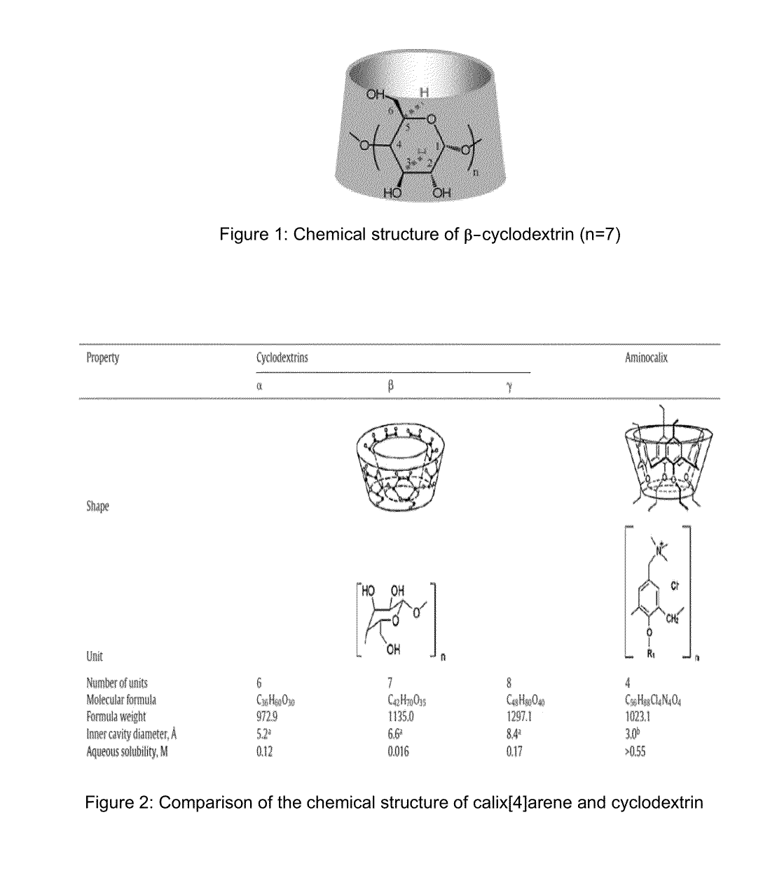

Native cyclodextrins (CD), because of their low solubility in water:127 g/l for α-CD, 18.8 g/l for β-CD and 236 g/l for γ-CD, can have a limit in their complexing properties, in particular in the case of β-cyclodextrin. In order to solve this, very soluble modified cyclodextrins and amorphous structures can be used. The presence of hydroxyl groups on the native cyclodextrins made it possible to develop cyclodextrins derivatives having an improved solubility. Indeed, native cyclodextrins have three types of alcohol groups: a primary alcohol group by molecular structure of glucose (position 6) and two alcohol groups by molecular structure of glucose (position 2 and 3), which represents 21 alcohol groups for β-CD likely to react (FIG. 1). Among these derivatives, partially or completely methylated cyclodextrins have distinctly a solubility in water improved compared to native cyclodextrins. Moreover, methylated cyclodextrins preserve the complexing properties of native cyclodextrins and can at the same time improve them, thanks to the electronic extension of the hydrophobic cavity by the substituted methyl functions. According to the size of the host molecules, their inclusion in the cavity of cyclodextrins is limited, for example the macromolecules, in particular the proteins and peptides. Moreover, the molar ratio cyclodextrin/host molecule is in general 1/1 or higher.

Cyclodextrin polymers, on the other hand, enjoy a number of advantages. As examples, they have higher molecular weight than cyclodextrins, the macromolecular structure of cyclodextrin polymers means that they can be considered to be biomaterials and the stability constants of the polymer-substrate complexes are often higher than those of cyclodextrin-drug complexes. As a result, hydrophobic, hydrophilic compounds and supramolecules are more readily complexed and less readily released by cyclodextrin polymers than by native cyclodextrins.

In 2001, Kosak, et al. according to US patent 20010034333 and US patent 2001021703, described the synthesis of polymers from cyclodextrins but by using an expensive and toxic process. To remedy to these disadvantages, Martel and al, according to the U.S. patent Ser. No. 09/913,475 (2001) described the synthesis of polymers from cyclodextrins without the use of organic solvent, but with a very low yield of soluble polymers (lower than 10%). In addition, the mechanical properties and the molecular weights of these cyclodextrin polymers are uncontrollable, with a low stability and a low molecular weight.

Research works of Martel B. and al. (J. of Applied Polymer Science, Vol. 97, 433-442, 2005) described a yield of 10% for obtaining soluble polymers and of 70% for obtaining insoluble polymers. These low yields are the result of a solubilization of the all reagents in an aqueous phase according to the reaction 1, and since the reaction of esterification is a balance, the displacement of this reaction will be done towards the contrary direction of the formation of ester with a poor yield of polycondensation of cyclodextrins and on the other hand, with a very high rate of polymers with very low molecular weight involving a purification step during a long time (60 hours of dialysis).

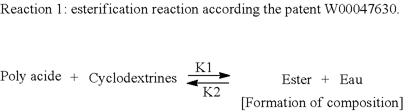

Another disadvantage according to this patent: on the one hand, the process of polymerization can be made only with crosslinking agents in the form of triacid or polyacid and not from monoacid or diacid agents because this process use a temperature of polymerization in the range 100° C. to 200° C. Patent WO 00/47630 does not allow the polymer synthesis from diacid (for example maleic acid) and tetra acid agents (for example EDTA) because it is necessary to heat respectively at the temperature of 210° C. and 270° C. Moreover, this previous process is limited by the aqueous solubility of the crosslinking agent. The polymers prepared from beta-cyclodextrins are very rigid, the polymers prepared from gamma-cyclodextrins are very flexible and the polymers prepared from alpha-cyclodextrins range between the two states.

In addition, all these patents described polymers containing only one type of cyclodextrin, so with a limited efficiency since the inclusion complexes are formed only according to the affinity of the guest molecule with the size of the cavity of cyclodextrin used. Thus, the development of new cyclodextrin polymers is needed in order to overcome the abovementioned limitations, more particularly in terms of molecular encapsulation and type of polymers. The use of a mixture of polymers synthesized from various cyclodextrins makes it possible to have a very great probability of obtaining various compounds of inclusion, a better stability and a better solubility of the pharmaceutical drugs.

The present invention proposes a new process for producing polymers, copolymers, terpolymers and tetrapolymers based on cyclodextrins or a mixture of two or three different cyclodextrins and/or their derivatives. This process is none polluting, cheap and can be used on an industrial scale with higher yields according to reaction 2.

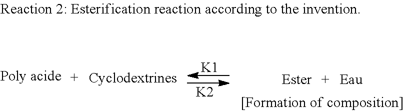

This new process does not use water as reactional medium but a fusion by heating of the crosslinking agent with a water elimination which is formed during polymerization.

This new process allows also the use of all types of acids and their derivatives, as crosslinking agent without being limited by their solubility in the reactional medium, and also obtaining polymers, copolymers, terpolymers and tetrapolymers based on cyclodextrins and/or a mixture of two or three different cyclodextrins and/or cyclodextrin derivative(s).

The mixture of cyclodextrins according to the present invention comprises at least two different cyclodextrins, which may each be present, in a content greater than or equal to 1% by weight, more particularly in a content greater than or equal to 10% by weight, or even in a content greater than or equal to 20% by weight, or even in a content greater than or equal to 30% by weight, or even in a content greater than or equal to 40% by weight, or even in a content greater than or equal to 50% by weight based on the total weight of the cyclodextrin.

In an alternative, the mixture of cyclodextrins comprises two cyclodextrins, more particularly:
an alpha-cyclodextrin/beta-cyclodextrin mixture, more particularly in a ratio comprised between 10/1 and 1/10, or even between 4/1 and 1/4,
an alpha-cyclodextrin/gamma-cyclodextrin mixture, more particularly in a ratio comprised between 10/1 and 1/10, or even between 4/1 and 1/4, or
a beta-cyclodextrin/gamma-cyclodextrin mixture, more particularly in a ratio comprised between 10/1 and 1/10, or even between 4/1 and 1/4.

According to another alternative, the mixture of cyclodextrins comprises three cyclodextrins, more particularly an alpha-cyclodextrin/beta-cyclodextrin/gamma-cyclodextrin mixture, more particularly with an alpha-cyclodextrin/beta-cyclodextrin ratio comprised between 10/1 and 1/10, or even between 4/1 and 1/4, and/or a beta-cyclodextrin/gamma-cyclodextrin ratio comprised between 10/1 and 1/10, or even between 4/1 and 1/4. According to another aspect, the mixture of cyclodextrins comprises three cyclodextrins, more particularly an alpha-cyclodextrin/beta-cyclodextrin/gamma-cyclodextrin mixture, more particularly with an alpha-cyclodextrin/beta-cyclodextrin ratio comprised between 10/1 and 1/10, or even between 4/1 and 1/4, and/or a beta-cyclodextrin/gamma-cyclodextrin ratio comprised between 10/1 and 1/10, or even between 4/1 and 1/4.

According to another of the all aspects, the object of the invention is a composition comprising or consisting in a mixture at least two different cyclodextrins selected from alpha-, beta-, and gamma-cyclodextrin and/or derivatives thereof and at least one cross-linking agent.

The composition may have cyclodextrin/cross-linking agent weight ratio greater than or equal to 0.5, more particularly greater than or equal to 1, or even greater than or equal to 2. More particularly, the composition comprises a content in crosslinking agent greater than or equal to 20% by weight, in particular greater than or equal to 30% by weight, advantageously greater than or equal to 40% by weight, more particularly greater than or equal to 50% by weight based on the total weight of the composition.

The composition may include at least two different cyclodextrins, each of these present in a content greater than or equal to 1% by weight, particularly in a content greater than or equal to 10% by weight, or event in a content greater than or equal to 20% by weight, or even in a content greater than or equal to 30% by weight, or even in a content greater than or equal to 40% by weight, or even in a content greater than or equal to 50% by weight based on the total weight of the composition.

The composition according to the invention may be in the form of liquid, particularly an aqueous liquid, a semisolid or solid. It can more particularly be in the form of a powder, tablets, capsules, a cream, an emulsion, more particularly an aqueous or oily emulsion, or even a multiple emulsion, of liposomes, nanoparticles, microparticules or a suspension. The composition according to the invention may be pharmaceutical, pharmafood, veterinary, chemistry, phytosanitation, nutraceutical, dietary, cosmetic, in the field of molecular imprints (MIP) or in the field of environmental comprising a composition according to the invention.

The method for the production of composition of copolymers, terpolymers and tetrapolymers soluble and/or insoluble made from:
cyclodextrin(s) and/or cyclodextrin derivative(s) and/or a mixture of different cyclodextrins,
and/or calix[n]arene(s) and/or calix[n]arene(s) derivative and/or a mixture of two or more different selected from calix[n]arene(s) (n=4-20) and/or the derivatives thereof, according to the invention and comprising the following operations:

Step 1: Introduction into a reactional medium of a crosslinking agent or a mixture of crosslinking agents in the form of solid, aqueous or organic solution or suspension, and a cyclodextrin or a mixture of two or three different cyclodextrins and/or their derivatives in the form of solid or suspension, with or without catalyst(s), in order to obtain a reactional mixture.

Step 2: Agitation of the reactional mixture for a time in the range 1 min. to 180 min., preferably, appreciably equalizes or equalizes to 3 min.

Step 3: Application of microwaves on the reactional mixture for a time in the range 5 seconds to 72 hours, preferably 1.5 min. with an energy of irradiation determined between 1 to 1000 watts, but preferably 100 watts and with a temperature of 140° C. to produce mainly soluble composition or 170° C. to produce mainly insoluble composition.

Step 4: The solid reaction product obtained according to the invention, was washed successively with three volumes of 20 mL of water and with two volumes of 50 mL of ethanol. The solid residue from washing was then dried at a temperature of 70° C. to obtain the insoluble composition.

Step 5: The first fraction of 60 mL from washing was filtered or dialyzed using a 12000-14000 D membrane. The resulting dialyzed solution was controlled by conductimetric measurements. In practice, the conductivity of distilled water used is measured at T0 (as of its recovery) and at T1 (after a dialysis for 18 hours) until obtaining a conductivity of T1 equal to that of T0.

Step 6: The resulting filtered or dialyzed solution was spray-dried or freeze-dried, representing the soluble composition.

Preferably, the mixture is heated to a temperature equal to or greater than 150° C., preferably about 170° C. for a time longer than 60 minutes, preferably under a vacuum, to produce mainly an insoluble composition. Alternatively, the mixture is heated to a temperature equal to or greater than 140° C., preferably at about 150° C., for a time longer than 20 minutes, preferably for about 30 minutes, preferably in a vacuum, to produce mainly the soluble composition.

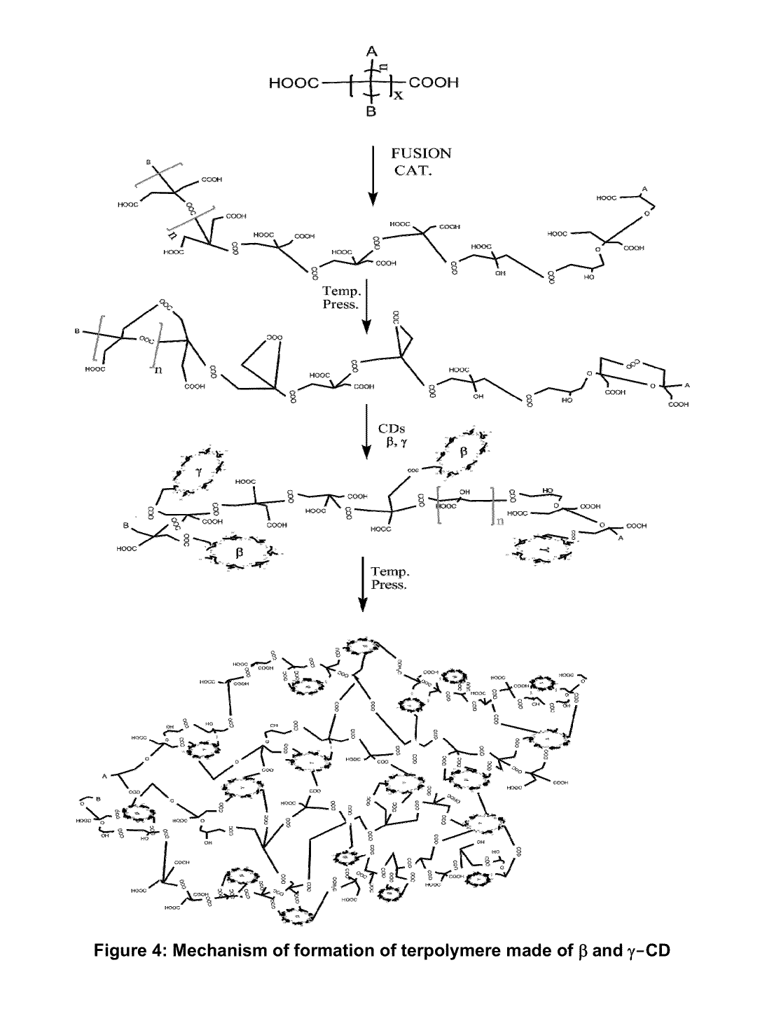

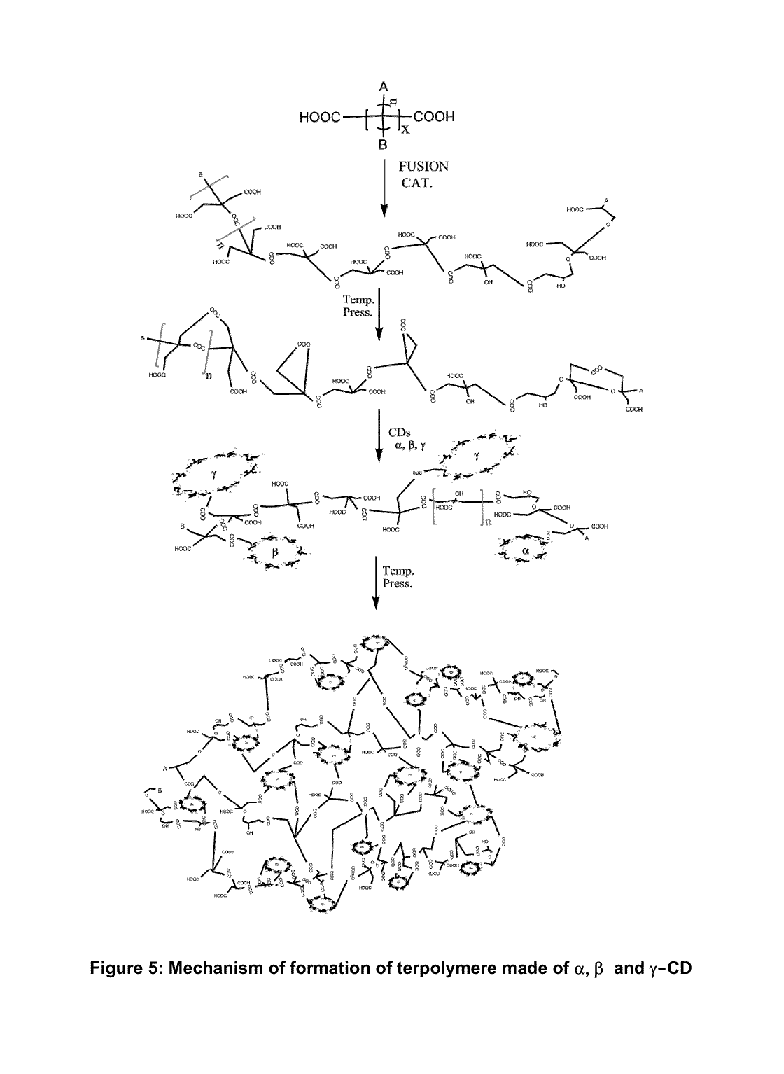

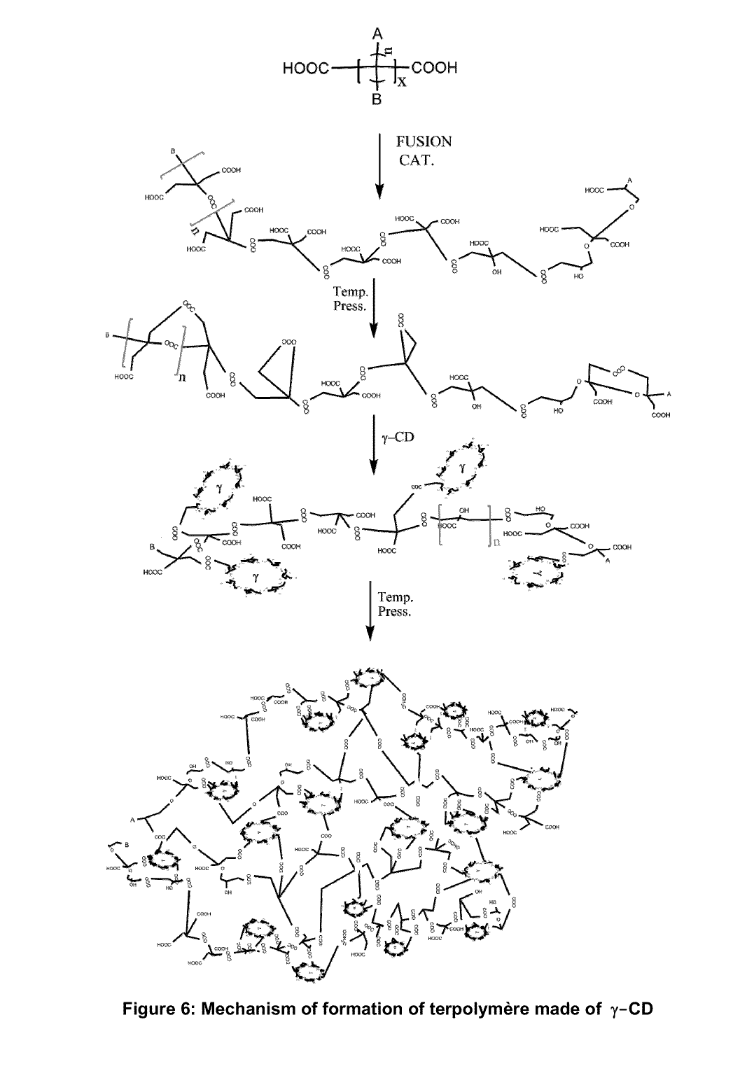

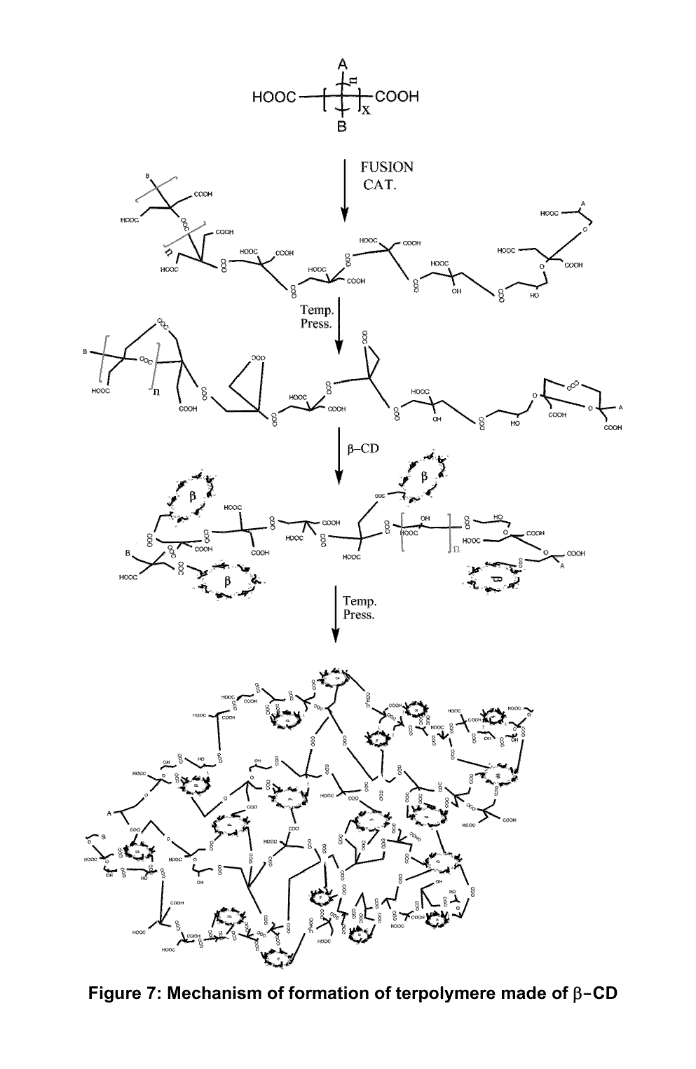

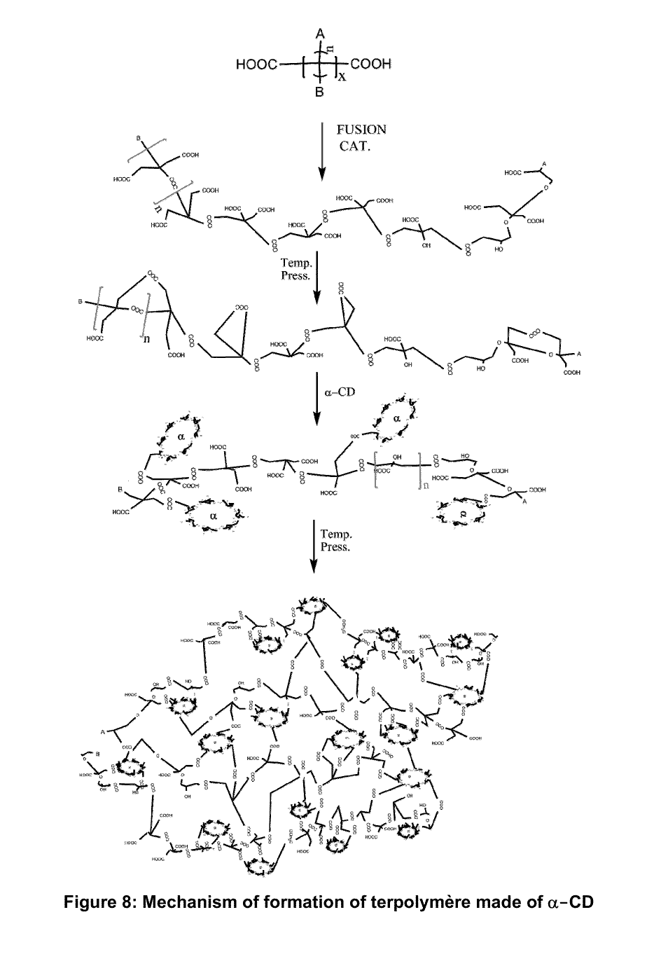

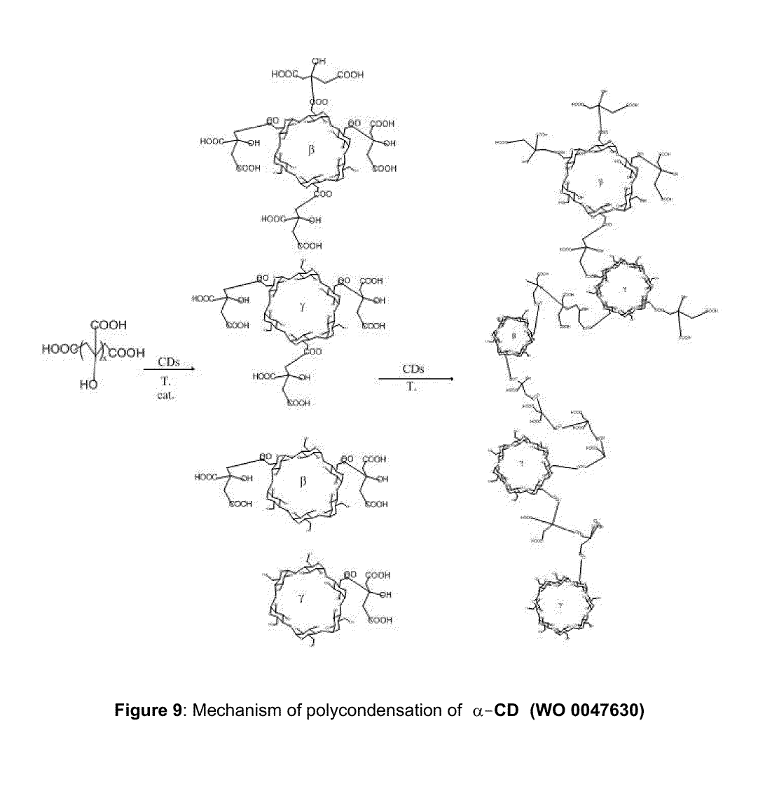

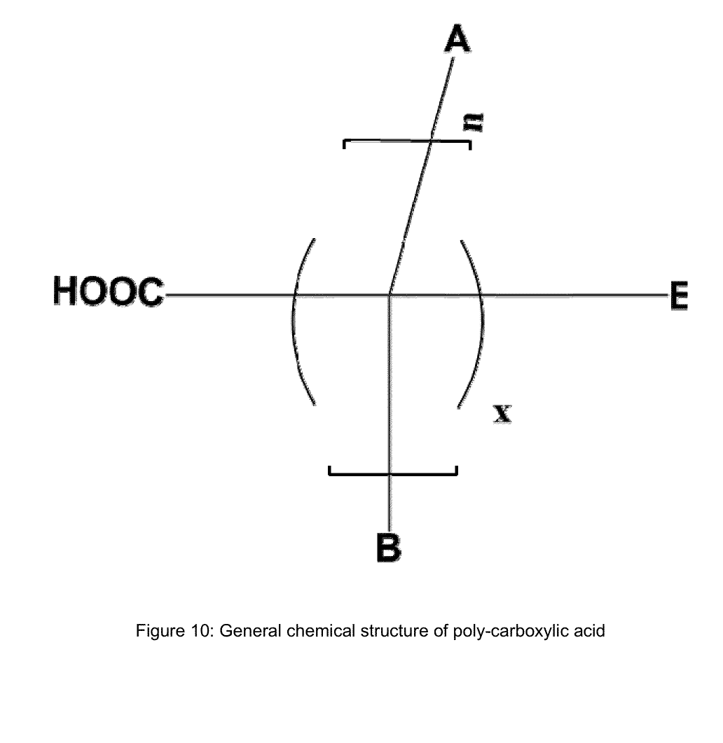

Mechanism of polymerization: The heating by microwaves allows firstly the condensation, and the majority of carboxylic functions of polyacid become anhydrous (FIGS. 3-8). Then, the anhydrous functions will react with hydroxyl groups of cyclodextrins. This mechanism is different from that according to patent WO 00/47630 which describes simultaneously the condensation of polyacid and the interaction with the hydroxyl groups of cyclodextrins, and which leads to compositions with very low molecular weights and with a very high index of polydispersity (FIG. 9).

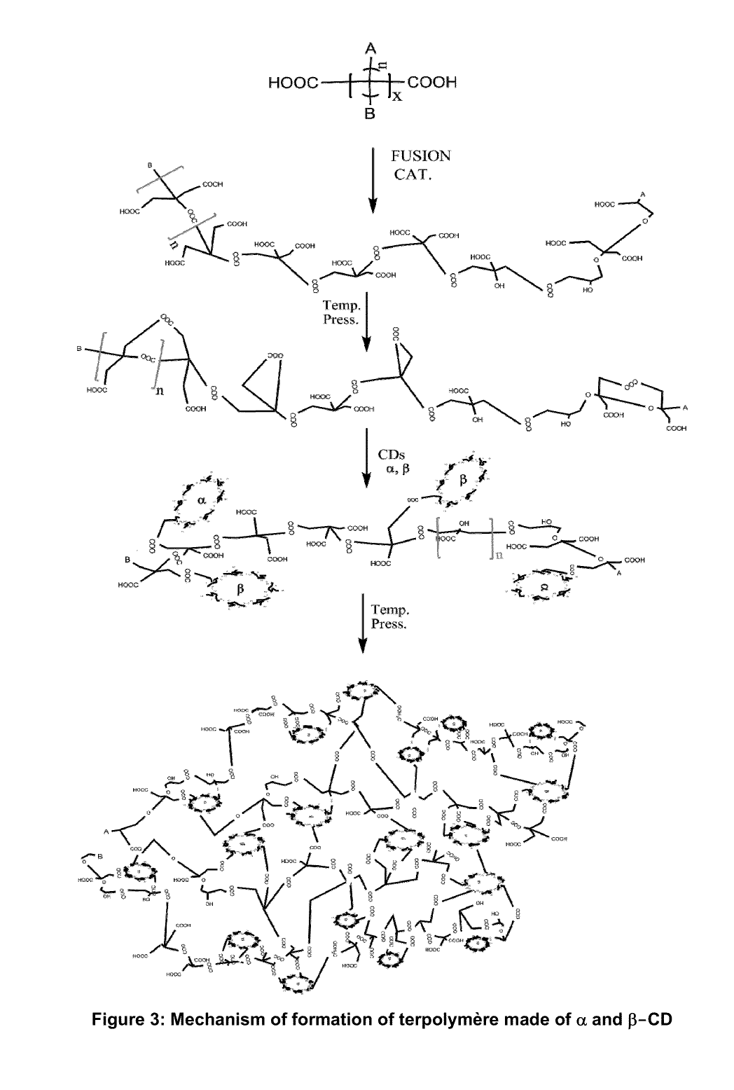

By analogy, the calixarenes are macrocyclic structures with complexing properties like cyclodextrins (FIG. 2). Calixarenes, of artificial origin, are macrocycles formed from “n” phenolic units (n=4 to 20) connected between them by methylene bridges on the ortho positions of phenol cycles.

The process of the invention can produce copolymers, terpolymers or tetrapolymers that include in their backbone, molecules of:
cyclodextrin(s) and/or cyclodextrin derivative(s), as well as copolymers, terpolymers or tetrapolymers that include molecules of cyclodextrin(s) and/or cyclodextrin derivative(s) as substitutes or side chains,
and/or calix[n]arene(s) and/or calix[n]arene derivative(s) and/or a mixture of two or more different selected from calix[n]arene(s) (n=4 to 20) and/or the derivatives thereof.

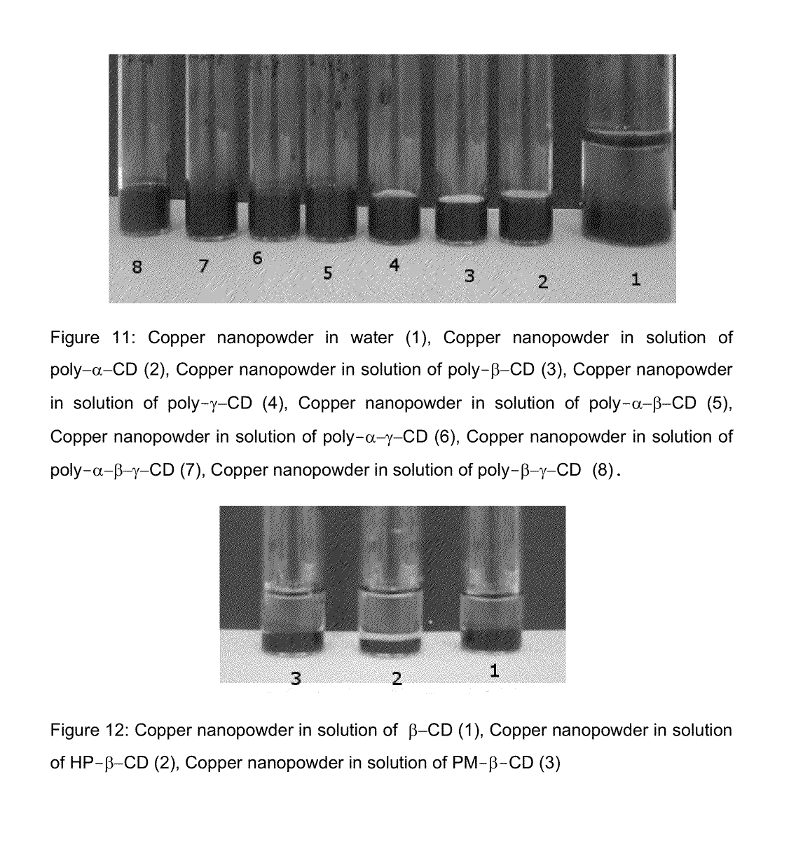

The process of the present invention is preferably applicable to cyclodextrin(s) selected from alpha-cyclodextrin, beta-cyclodextrin, and gamma-cyclodextrin and to hydroxypropyl, methyl, ethyl, sulfobutylether or acetyl derivatives of alpha-cyclodextrin, beta-cyclodextrin and gamma-cyclodextrin, and to mixtures formed from said cyclodextrins and said cyclodextrin derivatives and the crosslinking agent such as poly(carboxylic) acid or poly(carboxylic) acid anhydride selected from the following poly(carboxylic) acids and poly(carboxylic) acid anhydrides: saturated and unsaturated acyclic poly(carboxylic) acids, saturated and unsaturated cyclic poly(carboxylic) acids, aromatic poly (carboxylic) acids, hydroxypoly(carboxylic) acids, preferably selected from citric acid, poly(acrylic) acid, poly (methacrylic) acid, 1,2,3,4-butanetetracarboxylic acid, 1,2,3-propanetricarboxylic acid, aconitic acid, all-cis-t,2,3,4cyclopentanetetracarboxylic acid, mellitic acid, oxydisuccinic acid, and thiodisuccinic acid characterized in that the repeat unit has the following general formula (FIG. 10):

x et n=(1-10⁺⁸)

E: represents one of the functional groups for polycondensation mentioned in list Z

A, B: can be either a hydrogen atome (H) or a fluorine atom (F), or one of the functional groups mentioned in list G.

List (Z): list of condensation groups:

Carboxylic acid, amine, isocyanates and cyanamides and their derivatives, and other essential chemical groups for the condensation reaction are in the reference: Chemicals and Physicochemistry of polymers (Broché).

Michel Fontanille (Author), Yves Gnanou (Author).

Editor: Dunod ISBN-10: 2100039822—ISBN-13: 978-2100039821.

List G: list of functional groups:

acétal, acétoxy, acetylé, anhydride acide, acryle, groupes d′ activation et désactivation, acyles, acyle halide, acylal, acyloin, acylsilane, alcools, aldéhydes, aldimine, alcènes, alkoxyde, alkoxy, alkyles, alkyls cycloalcane, alkyls nitrites, alcyne, allene, allyles, amides, amidines, amine oxyde, amyle, aryle, arylene, azide, aziridine, azo, azoxy, benzoyle, benzyle, beta-lactames, bisthiosemicarbazone, biuret, acide boronique, butyles, carbamates, carbènes, carbinoles, carbodiimide, carbonate ester, carbonyles, carboxamide, carboxyles groupes, carboxylique acide, chloroformate, crotyles, cumulene, cyanamide, cyanates, cyanate ester, cyanamides, cyanohydrines, cyclopropane, diazo, diazonium, diols, énamines, énoles, enole éthers, énolate anion, élone, ényne, épisulfide, époxyde, éster, éthers, éthyles groupes, glycosidique liaisons, guanidine, halide, halohydrin, halokétone, hemiacetal, hemiaminal, hydrazide, hydrazine, hydrazone, hydroxamic acide, hydroxyl, hydroxyl radical, hydroxylamine, hydroxymethyl, imine, iminium, isobutyramide, isocyanate, isocyanide, isopropyl, isothiocyanate, cétyl, cétene, cétenimine, cétone, cétyl, lactam, lactol, mesylate, metal acetylide, méthine, méthoxy, méthyles groupes, methylene, methylenedioxy, n-oxoammonium salt, nitrate, nitrile, nitrilimine, nitrite, nitro, nitroamine, nitronate, nitrone, nitronium ion, nitrosamine, nitroso, nitrosyl, nonaflate, organique peroxyde, organosulfate, orthoester, osazone, oxime, oxon (chemical), pentyl, persistent carbene, phenacyl, phenyl groupes, phenylene, phosphaalcyne, phosphate, phosphinate, phosphine, phosphine oxyde, phosphinite, phosphite, phosphonate, phosphonite, phosphoniumes, phosphorane, propargyl, propyls, propynyls, sélenol, sélénonique acide, semicarbazide, semicarbazone, silyl enol éthers, silyl éthers, sulfide, sulfinique acide, sulfonamide, sulfonate, sulfonique acide, sulfonyl, sulfoxyde, sulfuryl, thial, thioacétal, thioamide, thiocarboxy, thiocyanate, thioester, thioéthers, thiokétal, thiokétone, thiols, thiourée, tosyl, triazene, triflate, trifluoromethyl, trihalide, triméthyle silyles, triol, urée, vanillyles, vinyles, vinyles halide, xanthate, ylide, ynolate, dérivés de silicone.

The catalyst is selected from dihydrogen phosphates, hydrogen phosphates, phosphates, hypophosphites, alkali metal phosphates, alkali metal salts of polyphosphoric acids, carbonates, bicarbonates, acetates, borates, alkali metal hydroxides, aliphatic amines and ammonia, preferably selected from sodium hydrogen phosphate, sodium dihydrogen phosphate and sodium hypophosphite. The catalyst can be associated with an inorganic solid support or a mixture of mineral solid support like alumina, silica gels, silica, Aluminum silicate, zeolites, titanium oxides, zirconium, niobium oxides, chromium oxides, magnesium or tin oxides to increase the heat-transferring surfaces during polymerization.

These compositions of copolymers, terpolymers and tetrapolymers made from cyclodextrin(s) and/or a mixture of different cyclodextrins, and/or cyclodextrin derivative(s) were obtained, but not exclusively, by the process of the present invention. They can be modified, ramified and/or cross-linked. Advantageously, the composition can include a positively charged compound, a negatively charged compound and/or modified compound(s) for example by fatty acid chains, PEG, PVP, chitosan, amino-acids.

The following examples the copolymers, terpolymers and tetrapolymers of the present invention are given for illustration and are not limitative.

### EXAMPLE 1

### Synthesis of soluble α-β-γ-CD tetrapolymers by polycondensation under microwave

A mixture of cyclodextrins (70 mg of α-cyclodextrin+70 mg of β-cyclodextrin+70 mg of γ-cyclodextrin), 210 mg of citric acid and 10 mg of Na₂HPO₄ were taken in a 100 mL round bottom flask fitted with a condenser. The flask was placed inside the microwave oven and irradiated. The optimal parameters for the reaction of polycondensation under microwave were summarized in tables 2-4:

1—Study of the Influence of the Irradiation Energy on the Polycondensation:

TABLE 2

| | | | | | Area of |
|---|---|---|---|---|---|
| IRRADI- | TEMPER- | HOLD | MASS | VOLUME | ester peak |
| ATION | ATURE | TIME | RATIO | H₂O | (FT-IR |
| (Watt) | (° C.) | (min) | (CD/AC) | (mL) | 1720 cm⁻¹) |
| 300 | 120 | 2.2 | 1 | 2 | 9650 |
| 300 | 130 | 2.2 | 1 | 2 | 10 000 |
| 300 | 140 | 2.2 | 1 | 2 | 10 500 |
| 300 | 150 | 2.2 | 1 | 2 | 10 300 |

An optimum of temperature is obtained at 140° C.

2—Study of the Influence of the Irradiation Energy on the Polycondensation:

The temperature was fixed at 130° C. and the irradiation energies varied as illustrate in table 3:

TABLE 3

| | | | | | Area of |
|---|---|---|---|---|---|
| IRRADI- | TEMPER- | HOLD | MASS | VOLUME | ester peak |
| ATION | ATURE | TIME | RATIO | H₂O | (FT-IR |
| (Watt) | (° C.) | (min) | (CD/AC) | (mL) | 1720 cm⁻¹) |
| 100 | 130 | 2.2 | 1 | 2 | 10 650 |
| 150 | 130 | 2.2 | 1 | 2 | 10 540 |
| 300 | 130 | 2.2 | 1 | 2 | 10 410 |

We obtained an optimum with 100 Watts for the power of radiation.

3—Study of the Influence of the Time of Polycondensation (Hold Time)

The influence of time reaction (Hold Time) was evaluated by fixing the other parameters summarized in table 4:

TABLE 4

| | | | | | Area of |
|---|---|---|---|---|---|
| IRRADI- | TEMPER- | HOLD | MASS | VOLUME | ester peak |
| ATION | ATURE | TIME | RATIO | H₂O | (FT-IR |
| (Watt) | (° C.) | (min) | (CD/AC) | (mL) | 1720 cm⁻¹) |
| 300 | 130 | 2.2 | 1 | 2 | 10 340 |
| 300 | 130 | 1.5 | 1 | 2 | 10 675 |
| 300 | 130 | 1 | 1 | 2 | 10 210 |

An optimum of polycondensation time is obtained at 1.5 min.

### EXAMPLE 2

### Synthesis of Alpha-Cyclodextrin Copolymers by Polycondensation Under Microwave

A mixture of 210 mg of alpha-cyclodextrins (210 mg), 210 mg of citric acid and 10 mg of Na₂HPO₄ were taken in a 100 mL round bottom flask fitted with a condenser. The flask was placed inside the microwave oven and irradiated. The optimal parameters for the reaction of polycondensation under microwave as obtained in example 1, were applied. The solid product obtained according to the invention, was washed successively with three volumes of 20 mL of water. The fraction of water (60 mL) from washing was filtered by membrane. The filtrate was then dried by spray-drying.

### EXAMPLE 3

### Synthesis of Beta-Cyclodextrin Copolymers by Polycondensation Under Microwave

A mixture of 210 mg of beta-cyclodextrins (210 mg), 210 mg of citric acid and 10 mg of Na₂HPO₄ were taken in a 100 mL round bottom flask fitted with a condenser. The flask was placed inside the microwave oven and irradiated. The optimal parameters for the reaction of polycondensation under microwave as obtained in example 1, were applied. The solid product obtained according to the invention, was washed successively with three volumes of 20 mL of water. The fraction of water (60 mL) from washing was filtered by membrane. The filtrate was then dried by spray-drying.

### EXAMPLE 4

### Synthesis of Gamma-Cyclodextrin Copolymers by Polycondensation Under Microwave

A mixture of 210 mg of gamma-cyclodextrins (210 mg), 210 mg of citric acid and 10 mg of Na₂HPO₄ were taken in a 100 mL round bottom flask fitted with a condenser. The flask was placed inside the microwave oven and irradiated. The optimal parameters for the reaction of polycondensation under microwave as obtained in example 1, were applied. The solid product obtained according to the invention, was washed successively with three volumes of 20 mL of water. The fraction of water (60 mL) from washing was filtered by membrane. The filtrate was then dried by spray-drying.

### EXAMPLE 5

### Synthesis of Soluble Alpha-Gamma-Cyclodextrin Terpolymers by Polycondensation Under Microwave

A mixture of 105 mg of alpha-cyclodextrins, 105 mg of gamma-cyclodextrins, 210 mg of citric acid and 10 mg of Na₂HPO₄ were taken in a 100 mL round bottom flask fitted with a condenser. The flask was placed inside the microwave oven and irradiated. The optimal parameters for the reaction of polycondensation under microwave as obtained in example 1, were applied. The solid product obtained according to the invention, was washed successively with three volumes of 20 mL of water. The fraction of water (60 mL) from washing was filtered by membrane. The filtrate was then dried by lyophilization.

### EXAMPLE 6

### Synthesis of Soluble Alpha-Beta-Cyclodextrin Terpolymers by Polycondensation Under Microwave

A mixture of 105 mg of alpha-cyclodextrins, 105 mg of beta-cyclodextrins, 210 mg of citric acid and 10 mg of Na₂HPO₄ were taken in a 100 mL round bottom flask fitted with a condenser. The optimal parameters for the reaction of polycondensation under microwave as obtained in example 1, were applied. The solid product obtained according to the invention, was washed successively with three volumes of 20 mL of water. The fraction of water (60 mL) from washing was filtered by membrane. The filtrate was then dried by lyophilization.

### EXAMPLE 7

Determination of the molar mass of cyclodextrin polymers obtained either by the new process (the invention) or according to patent WO 00/47630 (anterior art) by Size Exclusion Chromatography coupled with Multiangle Laser-light Scattering (SEC/MALLS)

This method makes it possible to determine the mass distributions of polymers synthesized according to the present invention. The Size Exclusion Chromatography (SEC) is carried out to separate the macromolecules according to their sizes (their hydrodynamic volume in solution). For that, the solutions of polymers were injected then eluted on columns which are filled with nonadsorbent porous material. At the exit of the column, the fractions are detected according to their properties. Contrary to the techniques based on standard polymers and to a simple detection of concentrations (usually with a differential refractometer), the addition of a second detection by diffusion of the multiangle laser light, sensitive to the molecular weights, gives access to instantaneous variations of the giration radius and the average molar mass (Mw) of the eluted species at each time of elution, and to come back to the total mass distribution.

The instrument is equipped with a degazer (ERC-413), a pump (Flom Intelligent Pump, Japan) at a flow rate of 0.6 mL/min⁻¹, a filter with pore size of 0.45 micrometers, an injector Rheodyne (100 μL), a guard column (OHpak SBG, Showa Denko) and two columns in series (OHpak SB-804 HQ and SB-806 HQ). The system is connected to a triple detection: diffusion of the multiangle laser light, diffusion of the quasi-elastique light and refractometric detection.

| | Mw (g/mol) | | |
|---|---|---|---|
| | WO 00/47630 | Present | Aqueous solubility |
| | Anterior art | invention | (mg/mL) |
| Poly alpha-CD | 100 000 | 250 000 | >1200 |
| Poly beta-CD | 100 000 | 270 000 | >1200 |
| Poly gamma-CD | 100 000 | 300 000 | >1200 |

### EXAMPLE 8

### Synthesis of Insoluble Alpha-Beta-Cyclodextrin Terpolymers by Polycondensation Under Microwave

Mixture of 105 mg of alpha-cyclodextrins, 105 mg of beta-cyclodextrins, 210 mg of citric acid and 10 mg of Na₂HPO₄ were taken in a 100 mL round bottom flask fitted with a condenser. The parameters (300 Watts—2 min.—170° C.) were applied to obtain the insoluble terpolymer. The solid product obtained according to the invention, was washed successively with three volumes of 20 mL of water and with two volumes of 50 mL of ethanol. The solid residue from washing was then dried at a temperature of 70° C. to produce the insoluble composition.

### EXAMPLE 9

### Synthesis of Insoluble Alpha-Beta-Cyclodextrin Terpolymers Containing EDTA By Polycondensation Under Microwave

Mixture of 105 mg of alpha-cyclodextrins, 105 mg of beta-cyclodextrins, 210 mg of ethylene diamine tetra acetic (EDTA) and 10 mg of Na₂HPO₄ were taken in a 100 mL round bottom flask fitted with a condenser. The parameters (300 Watts—4 min.—170° C.) were applied to obtain the insoluble terpolymer. The solid product obtained according to the invention, was washed successively with three volumes of 20 mL of water and with two volumes of 50 mL of ethanol. The solid residue from washing was then dried at a temperature of 70° C. to produce the insoluble composition.

### EXAMPLE 10

### Synthesis of Insoluble calix[4]arene Copolymers by Polycondensation Under Microwave

Mixture of 210 mg of calix[4]arenes, 210 mg of ethylene diamine tetra acetic (EDTA) and 10 mg of Na₂HPO₄ were taken in a 100 mL round bottom flask fitted with a condenser. The parameters (300 Watts—4 min.—170° C.) were applied to obtain the insoluble copolymers. The solid product obtained according to the invention, was washed successively with three volumes of 20 mL of water and with two volumes of 50 mL of ethanol. The solid residue from washing was then dried at a temperature of 70° C. to produce the insoluble composition.

### EXAMPLE 11

### Synthesis of Soluble calix[4]arene Copolymers by Polycondensation Under Microwave

Mixture of 210 mg of calix[4]arenes, 210 mg of ethylene diamine tetra acetic (EDTA) and 10 mg of Na₂HPO₄ were taken in a 100 mL round bottom flask fitted with a condenser. The parameters (300 Watts—4 min.—140° C.) were applied to obtain the soluble copolymers. The solid product obtained according to the invention, was washed successively with three volumes of 20 mL of water. The fraction of water (60 mL) from washing was filtered by membrane. The filtrate was then dried by spray-drying to obtain the soluble composition.

### EXAMPLE 12

### Molecular Encapsulation of Insoluble Antihelminthic <<Albendazole>> by Cyclodextrin Copolymers and Tetrapolymers

Albendazole (ABZ) is a benzimidazole derivative with a broad spectrum of activity against human and animal helminthe parasites. ABZ therapy is very important in systemic cestode infections. Its international nomenclature is methyl[5-(propylthio)-1-H-benzimidazol-2-yl]carbamate (FIG. 1). Its formula associates a benzene cycle and an imidazol cycle. Albendazole is a poorly water-soluble drug (5·10⁻⁴) and consequently, it is poorly absorbed from the gastro-intestinal tract. The complexation of various cyclodextrins on solubility of albendazole was studied. Native cyclodextrins, cyclodextrin copolymers and cyclodextrin tetrapolymers were used, according to Higuchi's method. Cyclodextrin tetrapolymers were composed of 70% alpha-CD, 10% beta-CD and 20% gamma-CD, and were synthesized by polycondensation under microwave, according to example 1. The ratio cyclodextrin/citric acid is ⅓.

Table 7 represents the solubility of albendazole with native and modified cyclodextrins, and with copolymers and tetrapolymers based on cyclodextrin(s). Solubilities were higher with synthesizing cyclodextrin copolymers and tetrapolymers according to the present invention.

TABLE 7

| poly CDs | [ABZ] max. (mg/mL) |
|---|---|
| poly alpha-CD | 26 |
| poly beta-CD | 10 |
| poly gamma-CD | 20 |
| poly (α,β,γ)-CD | 28 |
| alpha-CD | 0.279 |
| beta-CD | 0.0435 |
| gamma-CD | 0.029 |

### Apparent Solubilization of Albendazole by Copolymers, Terpolymers and Tetrapolymers Based on Cyclodextrin(s) and by Native Cyclodextrins

### EXAMPLE 13

### Stabilization of Copper Nanopowder Suspension by Copolymers, Terpolymers And Tetrapolymers Based on Cyclodextrins

Solutions of synthesizing copolymers, terpolymers and tetrapolymers based on cyclodextrins according to the present invention, with a concentration of 1% (WN), allow the stabilization of aqueous suspensions based on copper nanopowder (1% and 4%)(Picture 1). For only native cyclodextrin and cyclodextrin derivative(s) (HP-beta-CD and PM-beta-CD), a precipitation of copper nanopowder was visible 48 hours after the preparation of suspensions (picture 2).

The development of stable suspensions from copolymers, terpolymers and tetrapolymers based on cyclodextrins presents a major interest to improve the quality and the efficiency of the ferrofluids and catalysts.

1-15. (canceled)

16. A process for producing a composition, the process comprising the steps of:
creating a reactional mixture by adding to a reaction chamber a crosslinking agent and a component selected from the group consisting of calix[n]arene, cyclodextrin, a mixture of a plurality of calix[n]arenes, a mixture of cyclodextrins, a derivative of calix[n]arene, a derivative of cyclodextrin, and a catalyst, said crosslinking agent and said component consisting of a solid or suspension;
stirring the reactional mixture for a time in a range of about 1 minute to 180 minutes;
making a solid residue by applying microwaves to the reactional mixture:
for a time in a range of about 5 seconds to about 72 hours, with an energy of irradiation in a range about 1 watt to 1000 watts; and
at a temperature:
in a range of about 140 degrees Centigrade to about 150 degrees Centigrade to produce mainly a solid residue that is soluble; or
of about 170 degrees Centigrade to produce mainly a solid residue that is insoluble;
washing the solid residue, said washing comprising successively rinsing with three volumes of water and with two volumes of ethanol, said washing producing a wash solution and a washed solid residue;
drying the washed solid residue at a temperature of about 70 degrees Centigrade to obtain a composition that is insoluble;
separating any remaining solid residue from the wash solution using a procedure selected from the group consisting of filtration and dialysis; and
drying the wash solution by spray-drying, atomization or freeze-drying to obtain a composition that is soluble.

17. The process according to claim 16, wherein when the step of making a solid residue is conducted at a temperature of about 170 degrees Centigrade, then this step further includes holding this temperature for a time longer than 60 minutes so that the solid residue that is insoluble becomes a solid reaction product.

18. The process according to claim 17, further comprising the steps of:
washing with water the solid reaction product to produce a washed product;
filtering the washed product;
isolating from the filtrate a composition that is soluble, said isolating performed by a method selected from the group consisting of dialysis and filtration; and
drying the composition that is soluble, said drying performed by a method selected from the group consisting of lyophilization, atomization, and spray-drying.

19. The process according to claim 16, wherein the step of making a solid residue is carried out under vacuum.

20. The process according to claim 16, wherein when the step of making a solid residue is conducted at a temperature in a range of about 140 degrees Centigrade to about 150 degrees Centigrade, then this step further includes holding this temperature for a time period of about 30 minutes.

21. The process according to claim 16, wherein cyclodextrin present in the reactional mixture is at a content of at least 1 percent of the weight of the total mass of the reactional mixture.

22. The process according to claim 21, wherein the cyclodextrin is selected from the group consisting of:
a mixture alpha-cyclodextrin and beta-cyclodextrin;
a mixture alpha-cyclodextrin and gamma-cyclodextrin; and
a mixture beta-cyclodextrin and gamma-cyclodextrin.

23. A composition according to the claim 22, wherein the composition further comprises a compound that is positively charged, negatively charged or modified by fatty acid chains, PEG, PVP, chitosan, or amino-acids.

24. The process according to claim 16, wherein when the reactional mixture contains a mixture of cyclodextrins consisting of alpha-cyclodextrin, beta-cyclodextrin, and gamma-cyclodextrin, then:
the ratio of alpha-cyclodextrin to beta-cyclodextrin is within a range of 10/1 to 1/10;
the ratio of alpha-cyclodextrin to gamma-cyclodextrin within a range of 10/1 to 1/10; and
the ratio beta-cyclodextrin to gamma-cyclodextrin is within a range of 10/1 to 1/10.

25. The process according to claim 16, wherein when the reactional mixture contains calix[n]arene or calix[n]arene derivatives, then n is in a range of n=4-20.

26. The process according to claim 16, wherein when the reactional mixture contains calix[n]arenes or a calix[n]arene derivatives, then said calix[n]arene or calix[n]arene derivatives comprise two different calix[n]arene or calix[n]arene derivatives where n is in a range of n=4-20.

27. The process according to claim 16, wherein the reactional mixture contains a calix[n]arene and a cyclodextrin.

28. A composition made according to the claim 27, wherein the weight ratio of calix[n]arene and cyclodextrins to crosslinking agent is at least 0.5.

29. A composition obtained from the process according to claim 16, wherein the crosslinking agent is at least 20 percent by weight of the total mass of the reactional mixture.

30. A composition according to the claim 29, wherein said composition is in a form selected from the group consisting of a powder, tablet, capsule, pellet, cream, emulsion; said emulsion selected from the group consisting of an aqueous emulsion, an oily emulsion, a multiple emulsion, a solution, a colloidal solution, and a suspension.

31. The process according to claim 29, wherein the catalyst comprises a support, said support selected from the group consisting of an inorganic solid support, and a mixture of mineral solid support, said mixture of mineral solid support selected from the group consisting of alumina, silica gel, silica, aluminum silicate, zeolite, titanium oxide, zirconium, niobium oxide, chromium oxide, magnesium and tin oxide.

32. The process according to claim 16, wherein the catalyst is selected from the group consisting of dihydrogen phosphate, hydrogen phosphate, phosphate, hypophosphite, alkali metal phosphate, alkali metal salt of polyphosphoric acid, carbonate, bicarbonate, acetate, borate, alkali metal hydroxide, aliphatic amine and ammonia.

33. The process according to claim 16, wherein when the component contains cyclodextrin or cyclodextrin derivative,
said cyclodextrin is selected from the group consisting of alpha-cyclodextrin, beta-cyclodextrin, and gamma-cyclodextrin, and
said cyclodextrin derivative is selected from the group consisting of hydroxypropyl, methyl, ethyl, sulfobutylether, acetyl derivative of alpha-cyclodextrin, beta-cyclodextrin, gamma-cyclodextrin, and the binary or ternary mixture formed from said cyclodextrin and said cyclodextrin derivative.

34. The process according to claim 16, wherein the crosslinking agent is selected from the group consisting of poly(carboxylic) acid; poly(carboxylic) acid anhydride, saturated acyclic poly(carboxylic) acid, unsaturated acyclic poly(carboxylic) acid, saturated cyclic poly(carboxylic) acid, unsaturated cyclic poly(carboxylic) acid, aromatic poly (carboxylic) acid, and hydroxypoly (carboxylic) acid, said hydroxypoly (carboxylic) acid selected from the group consisting of citric acid, poly(acrylic) acid, poly (methacrylic) acid, 1,2,3,4-butanetetracarboxylic acid, 1,2,3-propanetricarboxylic acid, aconitic acid, all-cis-t,2,3,4cyclopentanetetracarboxylic acid, mellitic acid, oxydisuccinic acid, and thiodisuccinic acid.
